(19) United States
(12) Patent Application Publication
(10) Pub. No.: US 2024/0300104 A1
(43) Pub. Date: Sep. 12, 2024

(54) PROJECTED ISSUE DISPLAY FOR HUMAN INTERVENTION IN ROBOTIC SYSTEM

(71) Applicant: Dexterity, Inc., Redwood City, CA (US)

(72) Inventors: Robert Moreno, East Palo Alto, CA (US); Robert Holmberg, Mountain View, CA (US); Zhouwen Sun, San Mateo, CA (US)

(21) Appl. No.: 18/599,859

(22) Filed: Mar. 8, 2024

Related U.S. Application Data
(60) Provisional application No. 63/450,741, filed on Mar. 8, 2023.

(51) Int. Cl. B25J 9/16; B25J 15/00; B25J 19/02

(52) U.S. Cl. CPC B25J 9/1661; B25J 9/161; B25J 9/1697; B25J 15/0019; B25J 19/023

(57) ABSTRACT

A robotic system is disclosed. The system includes a robotically-controlled equipment comprising a laser or other projector. An indication is received of an issue to be resolved by an intervening worker with respect to a target object. The robotically-controlled equipment is positioned to direct a projection emitted by the projector onto the target object.

### CROSS REFERENCE TO OTHER APPLICATIONS

This application claims priority to U.S. Provisional Patent Application No. 63/450,741 entitled LASER GUIDED ISSUE DISPLAY FOR HUMAN INTERVENTION IN ROBOTIC SYSTEM filed Mar. 8, 2023 which is incorporated herein by reference for all purposes.

### BACKGROUND OF THE INVENTION

Robotic systems have been provided to automated or partly automate logistics industry and related tasks, such as sortation/singulation, palletization/de-palletization, truck or container loading/unloading, line kitting, shelf kitting, etc.

Such robotic systems can enter states or conditions that require human intervention, such as robots and/or peripheral devices becoming unplugged (or not fully connected), pneumatic hoses being kinked or broken, packages or other items being too heavy for the robot to handle, jams that prevent free or continued flow of items, such as to a location from which a robot is configured to pick items, packages or other items dropped out of reach of the robot(s), etc.

Downtime for production systems is costly to the logistics industry. Operator turnover is high and training minimal. An untrained or uncareful human worker may not readily see the condition the robotic system requires the human to resolve and/or may not know how or the best way to resolve it. Lack of training and attention to detail can cost logistics operations millions of dollars in maintenance, missed deliveries, damage customer relationships, and can ruin a company's reputation.

### BRIEF DESCRIPTION OF THE DRAWINGS

Various embodiments of the invention are disclosed in the following detailed description and the accompanying drawings.

FIG. 1 is a block diagram illustrating an embodiment of a robotic system to indicate the location and, optionally, nature of an issue required to be resolved by an intervening worker.

FIG. 2 is a flow diagram illustrating an embodiment of a process to indicate the location and, optionally, nature of an issue required to be resolved by an intervening worker.

FIG. 3 is a diagram illustrating an example of color and/or shape encoded images such as may be projected onto an item in an embodiment of a robotic system to indicate the location and, optionally, nature of an issue required to be resolved by an intervening worker.

FIG. 4 is a diagram illustrating an example of a visual indication such as may be projected onto an item in an embodiment of a robotic system to indicate the location and, optionally, nature of an issue required to be resolved by an intervening worker.

FIG. 5 is a diagram illustrating an example of a workspace, system, and environment in which a system as disclosed herein may be used.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An automated system is disclosed to increase operator productivity and awareness for keeping robotic systems online and functionally available. In various embodiments, techniques disclosed herein enable operators without robotic or sub-systems/component vocabulary to understand visually, as quickly as possible, where an issue is located on the system and/or how to correct it. In some embodiments, techniques disclosed herein are used to indicate the location and/or nature of an issue required to be resolved by a downstream worker. In various embodiments, the downstream worker may be a relatively less trained human worker, a highly trained human worker, or a robot.

In various embodiments, the multiple degrees of freedom of the robot (e.g., robotic arm) are used to position and orient the end-effector to the robot to enable a laser (or other light) pointer and/or projector to be pointed at the item/equipment that requires human (or other) intervention. In some embodiments, the color or other attribute of the light and/or an icon, alphanumeric character, string, or sequence, or other symbolic information is projected on the item/equipment, to indicate the intervention that is needed.

In various embodiments, a toggleable projector/laser is provided to display visuals from the tool or robot arm. Control software is used to calculate the distance and Euler angle required to point the visual projection of text, pictures, graphics, dot, pattern, shape, etc. in the location of the issue, enabling operators to quickly see where the problem is and how to respond to it.

In various embodiments, one or more of the following are achieved/performed:
First, the software detects an issue whether it is physically on the working area (for example: conveyor, tray pallet, wall) or external but comprises part of the system (for example: camera, cable, or sensor).
Second, the software puts the robot in a safe position, calculates the vector and distance needed to highlight the affected area or component, and rotates the tool or arm containing the projection system accordingly until the desired location is reached. The laser is then toggled on visually indicating what needs to be fixed. In some embodiments, more details such as instructions as to what to do in the affected area are found in messaging displayed via a user interface available to the human worker, e.g., via a mobile device.
Finally, after the issue is resolved or cleared, the robot returns to an operating state and position. The laser toggles off and production/operations resume.

Techniques disclosed herein may be used in a variety of contexts, including without limitation assistance to production capabilities of the robotic system, corrective maintenance, preventive maintenance, and issue resolution.

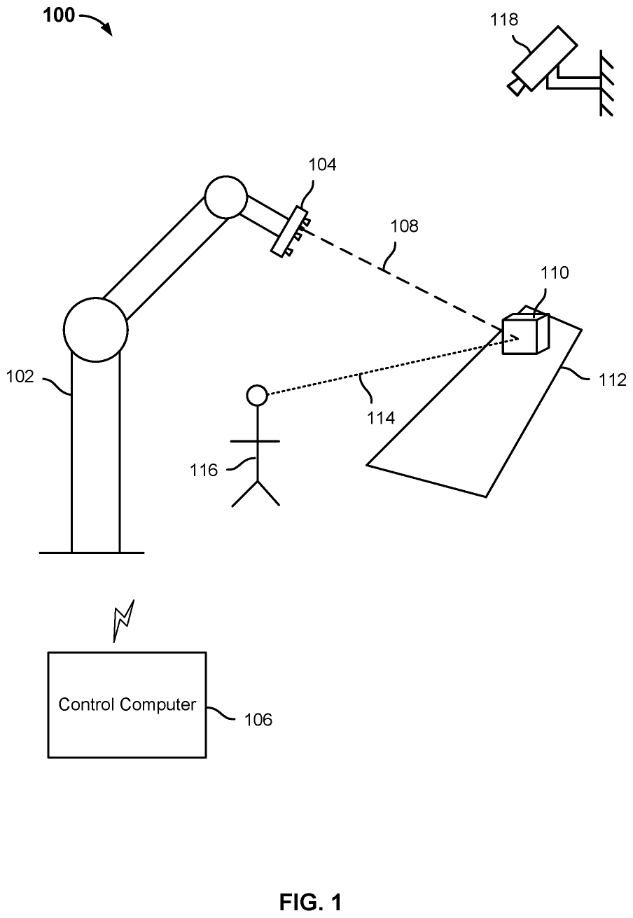

FIG. 1 is a block diagram illustrating an embodiment of a robotic system 100 to indicate the location and, optionally, nature of an issue required to be resolved by an intervening worker, such as a human worker or another robot. In the example shown, robotic arm 102 has a suction-type end effector 104 on which a laser pointer or projector has been mounted and/or is otherwise integrated. An issue requiring intervention has been detected, e.g., by control computer 106. The robotic arm 102 has been controlled by control computer 106 to move the end effector 104 to the position and orientation as shown, which has enabled the laser pointer/projector integrated into and/or mounted on the end effector 104 to be used to direct laser projection 108 onto the item 110 that requires intervention.

In the example shown in FIG. 1, item 110 is illuminated by laser projection 108 as it sits on surface 112, e.g. a worktable, conveyor, or other structure. In various embodiments, the control computer 106 takes into consideration the target (e.g., item 110) with respect to which intervention is required (what to project onto), the nature of the problem (what image/color to project), obstacles in the space (where to position laser to project onto target), and the line of sight 114 of the human worker 116.

In various embodiments, images generated by one or more cameras 118 in the workspace, e.g., mounted in fixed positions (e.g., poles or walls) in the workspace and/or mounted on and/or otherwise integrated into robotic arm 102 and/or end effector 104, to detect the issue required to be resolved and/or to calculate the position and orientation the end effector 104 is required to be moved into in order to project the laser projection 108 onto the item 110.

In some embodiments, the item 110 may be moving, e.g., in a flow of items down a chute or along the surface of a conveyor belt or other conveyance structure. In such cases, in various embodiments, one or both of the robotic arm 102 and the end effector 104 may be moved, as/if required, under the control of control computer 106 to maintain the laser projection 108 pointing at the location of the issue on item 110 as it moves along/with the surface 112. In some embodiments, responsibility to project the laser projection 108 onto the relevant location on item 110 may be handed off, e.g., to a downstream robot, e.g., as the item 110 moves past the robotic arm 102. In some embodiments and/or contexts, control computer 106 may be configured to slow or stop the conveyance structure (e.g., 112) to allow time for the human (or other) worker 116 to intervene and resolve the issue prior to the item 110 moving past a position in which robotic arm 102 and end effector 104 are able to be used to project the laser projection 108 onto the item 110.

While in the example shown in FIG. 1 the laser projection 108 is emitted from a laser mounted on or integrated into the end effector 104 of robotic arm 102, in various other embodiments the laser may be mounted in the workspace, e.g., on a wall, pole, or other structure. In such embodiments, control computer 106 may be configured to control the pan, tilt, or other motion of the laser/projector, e.g., to point the laser projection emitted from the laser onto the relevant part of item 110.

While a laser and associated laser projection 108 are described as being used in the example shown in FIG. 1, in other embodiments other sources and/or types of light in a spectrum that is visible to a human (or other) worker may be used. For example, infrared or ultraviolet light visible to a robotic worker or a worker wearing specialize goggles, glasses, or other headwear may be used. In some embodiments, virtual reality technology may be used to superimpose a virtual indication of an issue onto the affected location, e.g., of item 110.

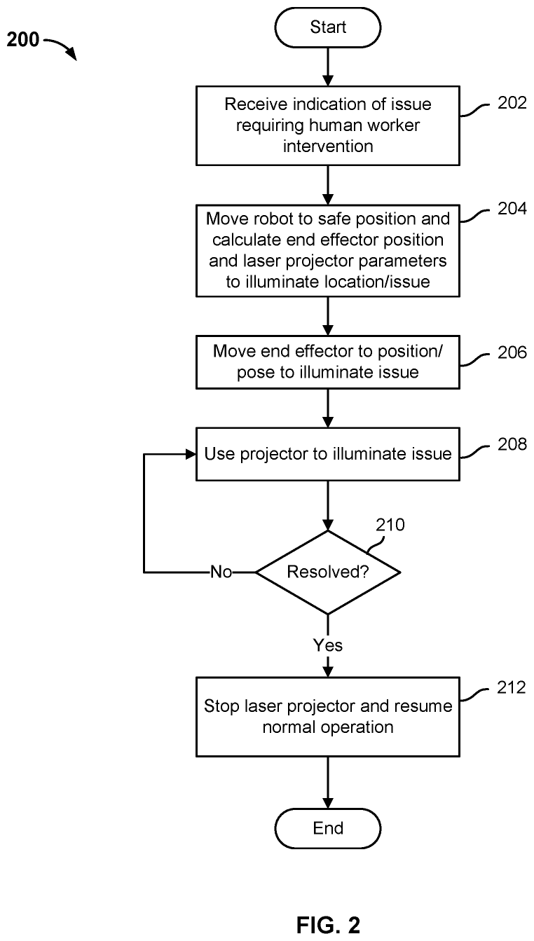

FIG. 2 is a flow diagram illustrating an embodiment of a process to indicate the location and, optionally, nature of an issue required to be resolved by an intervening worker, such as a human worker or another robot. In various embodiments, the process 200 of FIG. 2 may be performed by a control computer, such as control computer 106 of FIG. 1. In the example shown, at 202, an indication is received of an issue requiring intervention by a human (or other) worker. Examples include, without limitation, detecting that an item may be damaged and need to be extracted from further automated processing; determining a label could not be scanned or otherwise read, or that the item has been placed in an orientation that obscures a label, or the item is in flexible packaging (e.g., a polybag) and needs to be flattened or otherwise rearranged to enable information to be read; determining an item is too large or heavy for downstream handling and needs to be diverted; etc.

At 204, to robot handling the item(s) with respect to which the indication of an issue as received at 202 is more to a safe position and the end effector position and laser projector parameters (color of light, shape to be projected, energy/intensity required to illuminate the affect item(s) at the applicable distance, etc.) are calculated. In various embodiments, the robot moved to the safe position at 204 may be the same as or different than the robot or other robotically controlled equipment that will be used to project the laser projection onto the affected item(s). At 206, the end effector (or other robotically controlled equipment) into/onto which the laser projector is mounted and/or otherwise integrated is moved into the position and pose (orientation) as calculated at 204. At 208, the laser projector is activated and used to project the laser projector to illuminate the issue that needs to be resolved.

The laser projector continues to be directed at the item/location until the issue has been resolved (210). For example, the computer implementing process 200 may observe the scene and determine, e.g., based on image data from one or more cameras, that the issue has been resolved. In some embodiments, the end effector used to project the laser projection also includes or has mounted thereon a camera, which may be used to observe and detect whether the issue has been resolved. In some embodiments, a human worker dispatched to resolve the issue may indicate, e.g., via a user interface, that the issue has been resolved.

Once it is determined, at 210, that the issue has been resolved, at 212 the laser projector is deactivated and the robot(s) resume normal operation.

In some embodiments, techniques disclosed herein may be used to project information other than and/or in addition to projecting onto the item itself. For example, a projection may be used to indicate the location, orientation, etc. at which the item is to be placed.

In some embodiments, information may be projected onto an item or set of items other than to indicate a problem. For example, a bar code, QR code, or other optically scannable information may be projected onto a box, pallet, or other container to indicate that robotic loading of the container has been completed. A human or other robotic worker may use a mobile device or other scanner to scan the code and then initiate a next phase of a workflow, such as to use a device to relocate the container and/or to call or otherwise invoke another human or robotic worker to relocate or perform another task or operation with respect to the container.

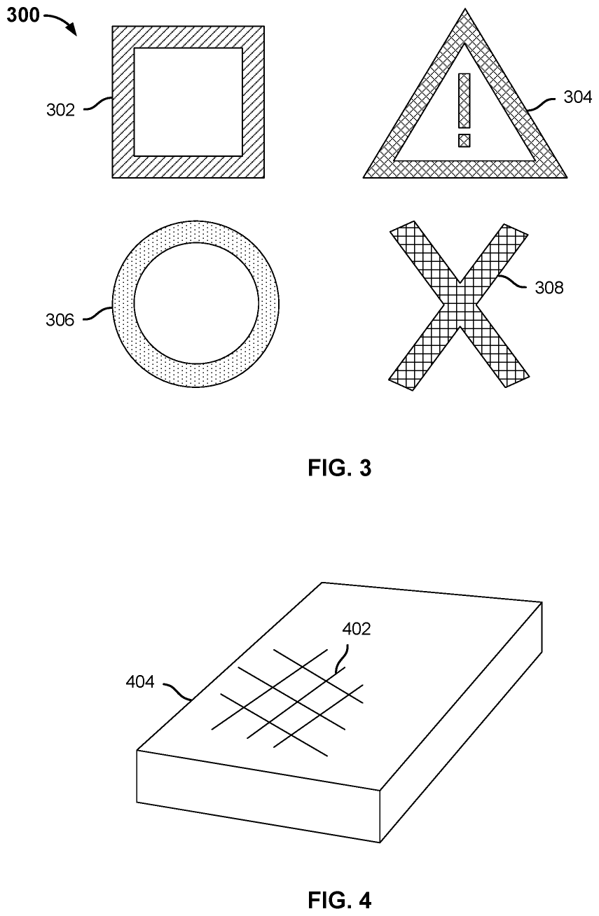

FIG. 3 is a diagram illustrating an example of color and/or shape encoded images such as may be projected onto an item in an embodiment of a robotic system to indicate the location and, optionally, nature of an issue required to be resolved by an intervening worker, such as a human worker or another robot.

In various embodiments, a system as disclosed herein may project an optionally color-coded shape or symbol. The shape or symbol may be projected onto the target with respect to which human or other intervention may be required, and the shape or symbol and/or color may indicate the action that is needed. For example, the shape/color set 300 shown in FIG. 3 may be used as follows:

Red square 302: item needs to be flattened out or reoriented for scanning.

Yellow triangle 304: item not recognized or expected, or “see user interface for instructions”.

Blue circle 306: check connection of chord, hose, cable, etc.

Red “X” 308: clear jammed flow of items through chute or conveyor or remove for manual handling an item too heavy for the robot or an item that has been dropped on the floor and the robot cannot retrieve.

Any shapes, colors, text, codes, or other human-intelligible ways to encode/communicate information may be used. For example, a short alphanumeric or other sequence of characters; a bar code, QR code, or other scannable optical code; and/or on or mre images may be projected. A human worker may enter the sequence into a user interface, scanned the optical code, etc., if/as needed, to receive more specific information about the intervention that is required. In some embodiments, a downstream robot and/or computer may use computer vision to perceive the laser or other image(s) as projected onto the item and map the image to a corrective action, e.g., by performing a lookup. The required action may then be displayed to a human worker, e.g., via a user interface, or text to voice technology may be used to provide a human audible instruction(s).

FIG. 4 is a diagram illustrating an example of a visual indication such as may be projected onto an item in an embodiment of a robotic system to indicate the location and, optionally, nature of an issue required to be resolved by an intervening worker, such as a human worker or another robot. In the example shown, a system as disclosed herein has been used to project a mesh pattern 402 to indicate more precisely or specifically the area or region of concern on item 404, such as the specific location of damage perceived on a parcel or to indicate a set of items to be reoriented or unjammed, or the location of a shipping label that must be scanned manually or flattened or reoriented to facilitate automated scanning.

While in the example shown in FIG. 4 the pattern 402 comprises a mesh pattern, in other embodiments other patterns (e.g., dots or arrays other small shapes) or continuous illumination of just the affected part(s) of the item 404 may be used.

While in various embodiments described herein the laser pointer or projector is mounted on or otherwise integrated with a robotic arm and/or end effector, in other embodiments the pointer or projector may be mounted on a pole or other structure in the workspace. Electronic or electromechanical techniques and structures may be used to point the laser at the target of concern, such as motors to rotate/pan/tilt the laser or projector. In some embodiments, the system may move the robotic arm, if needed, to provide a clear path for a fixed laser/projector to project onto a target.

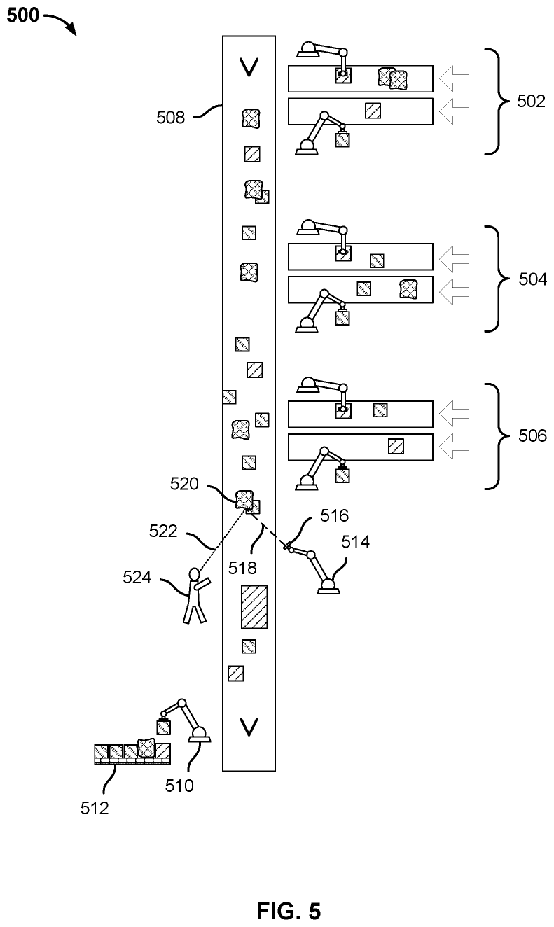

FIG. 5 is a diagram illustrating an example of a workspace, system, and environment in which a system as disclosed herein may be used. In the example shown, workspace, system, and environment 500 depicts a robotic logistics system comprising a plurality of robotic singulation stations 502, 504, and 506, each configured to use one or both of two robotic arms to pick items from a source chute or conveyor and place them singly on a destination conveyor 508. For example, items may be placed on destination conveyor 508 to be carried to downstream structures used to route the items each to a downstream location associated with its ultimate destination, such as a physical address to which the item is to be delivered, or to be loaded by robot 510 onto pallet 512, in the example shown in FIG. 5. However, for such downstream routing to be performed, it may be necessary for the items each to have a label successfully read at the singulation stations 502, 504, and 506 and/or that the item(s) be placed on the conveyor 508 in a way that allows for downstream structures (e.g., fixedly mounted scanners or cameras, downstream robots) to be used to read the label(s) and/or for items to be placed not too near or too far from one side or the other of the conveyor 508 and/or that items not be bunched together, etc.

In the example shown in FIG. 5, robotic arm 514 has been used to position and orient end effector 516 to direct a laser projection 518 to illuminate item 520, optionally in a manner (e.g., location, color, shape, etc.) that indicates the nature of the issue and/or the corrective action that is required to be taken. For example, a control computer (not shown) may have used image data from the workspace to detect that the item 520 and an adjacent item were bunched together. The control computer in response determined the angle at which to project the laser projection 518 and how to control/position robotic arm 514 and end effector 516 to project the laser projection 518 onto the item 520 at the calculated angle and, optionally, projecting a color, shape, pattern, etc. indicating the issue to be resolved. The control computer, in various embodiments, would take into consideration line of sight 522 of human worker 524 in calculating the angle at which to direct laser projection 518 onto item 520.

In various embodiments, computer vision may be used to observe/detect that the human worker 524 has resolved the issue, and in response the laser projection 518 may be discontinued.

In various embodiments, techniques disclosed herein may be used to detect issues and illuminate items in a manner that indicates one or more of the affected item(s), the specific affected area on/of the item, and the nature of the intervention that is required.

In various embodiments, techniques disclosed herein may be used to indicate the specific location or target with respect to which intervention is needed and, optionally, the nature of the intervention that is required.

Techniques disclosed herein may increase production up time of a robotic system. Uptime and throughput may be increased, including by more efficient and effective use of human operators without automation or robotic vocabulary, enabling them to operate/assist a complex robotic system and, over time, build their robotic system vocabulary through visual indicators and associated text-based user interfaces.

Techniques disclosed herein may be used, in various embodiments, in any context, including without limitation any fixed or mobile robotic system configured to sort, singulate, palletize, de-palletize, load, unload, or otherwise handle parcels or other items.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic system, comprising:
a robotically-controlled equipment comprising a projector, the robotically-controlled equipment being configured to be positioned to direct a projection emitted by the projector onto a target object in a workspace; and
a processor coupled to the robotically-controlled equipment and configured to:
receive an indication of an issue to be resolved by an intervening worker with respect to the target object; and
position the robotically-controlled equipment to direct the projection emitted by the projector onto the target object.

2. The system of claim 1, wherein the robotically-controlled equipment comprises a robotic arm.

3. The system of claim 2, wherein the projector is mounted on or otherwise integrated into an end effector attached to a distal end of the robotic arm.

4. The system of claim 2, wherein the processor is configured to pause or postpone a task the robotic arm was being used or was being prepared to be used to perform with respect to the target object in response to receiving said indication of the issue to be resolved by an intervening worker with respect to the target object.

5. The system of claim 1, wherein the projector comprises a laser projector and the projection comprises a laser projection projected onto the target object.

6. The system of claim 1, wherein the projection includes a color associated with the issue to be resolved with respect to the target object.

7. The system of claim 1, wherein the projection causes a shape or other graphic associated with the issue to be resolved with respect to the target object to be projected onto the target object.

8. The system of claim 1, wherein the processor is further configured to direct the projection onto a specific part of the target object with respect to which the issue is to be resolved.

9. The system of claim 1, wherein the projection causes a mesh or array to be projected onto the target object and the processor is further configured to direct the projection onto a specific part of the target object with respect to which the issue is to be resolved.

10. The system of claim 1, wherein the processor is configured to position the robotically-controlled equipment at least in part by computing one or more Euler angles.

11. The system of claim 1, wherein the processor is configured to take into consideration, when positioning the robotically-controlled equipment, a line of sight of the intervening worker.

12. The system of claim 1, further comprising a camera positioned and configured to generate image data of the workspace and wherein the processor is coupled to the camera and is further configured to use the image data to detect the issue the be resolved by the intervening worker.

13. The system of claim 1, wherein the processor is further configured to display to the intervening worker, via a displayed user interface, information associated with the issue to be resolved by the intervening worker.

14. The system of claim 1, wherein the processor is further configured to slow or interrupt a task being performed in the workspace with respect to the target object to enable the issue to be resolved.

15. The system of claim 1, wherein the target object is moving through the workspace and the processor is configured to track the target object and to reposition the robotically-controlled equipment as needed to continue to direct the projection emitted by the projector onto the target object.

16. The system of claim 1, wherein the processor is further configured to receive an indication that the issue has been resolved.

17. The system of claim 16, wherein the processor is configured to determine based on one or more images of the workspace that the issue has been resolved.

18. The system of claim 1, wherein the processor is further configured to cause the robotically-controlled equipment to resume a previously-interrupted task based at least in part on the indication that the issue has been resolved.

19. A method, comprising:
receiving an indication of an issue to be resolved by an intervening worker with respect to a target object in a workspace; and
positioning a robotically-controlled equipment to direct onto the target object a projection emitted by a projector comprising the robotically-controlled equipment.

20. A computer program product embodied in a non-transitory computer readable medium and comprising computer instructions for:
receiving an indication of an issue to be resolved by an intervening worker with respect to a target object in a workspace; and
positioning a robotically-controlled equipment to direct onto the target object a projection emitted by a projector comprising the robotically-controlled equipment.
